(19) United States
(12) Patent Application Publication
(10) Pub. No.: US 2014/0166468 A1
(43) Pub. Date: Jun. 19, 2014

(54) PORTABLE AND STATIONARY DISTILLATION UNIT FOR THE SIMULTANEOUS PRODUCTION OF DISTILLED WATER AND SALT, ENHANCHED BY SOLAR COLLECTORS

(71) Applicants: Georgios Hatzigiannis, Athens (GR); Vassilion Hatzigiannis, Athens (GR); Zio Hatzigianni, Athens (GR)

(72) Inventors: Georgios Hatzigiannis, Athens (GR); Vassilion Hatzigiannis, Athens (GR); Zio Hatzigianni, Athens (GR)

(21) Appl. No.: 14/234,163

(22) PCT Filed: Jul. 30, 2012
(86) PCT No.: PCT/GR2012/000037

§ 371 Date: Jan. 22, 2014

(30) Foreign Application Priority Data
Aug. 8, 2011 (GR) 20110100476

(51) Int. Cl. C02F 1/14; C02F 1/18

(52) U.S. Cl. CPC C02F 1/14; C02F 1/18
USPC 203/10; 202/185.1

(57) ABSTRACT

The invention describes a new and simple method of construction of a stationary distillation unit and of a small portable distillation unit. The evaporation pans are made of simple materials and are covered with a transparent film. Additionally in the small portable unit its evaporation pan has a double bottom, which receives hot water. By connection of the evaporation pan with the solar collectors (12) its productive ability significantly increases. The portable and stationary desalination units of the invention use solar power exclusively and simultaneously produce two products: distilled water and salt. The exploitation of solar radiation occurs both in the part of the unit covered by the transparent film as well as in the use of hot water produced by the solar collector connected to it, thus speeding up the evaporation of sea water. The transparent film, besides helping increase and hold the heat inside the production space, also protects the production space from pollutants in the environment, and as a result the products do not need further processing before being sent to consumption. Besides the fact that each unit can be used as an autonomous production unit of distilled water and salt, the units can also function as sub-units of a production line of an unlimited number of sub-units, where their combined use functions as a large production unit of distilled water and salt.

### SCOPE OF THE INVENTION

The invention presents an environmentally friendly method of construction and operation of a small portable distillation unit, as well as of a stationary distillation unit, for the simultaneous production of distilled water and salt in controllable conditions without use of electrical power.

Both portable and stationary distillation unit can be used anywhere selected, as autonomous unit for the production of distilled water and salt, when sea-water is inserted and distilled water and salt are produced. Also, both portable and stationary distillation unit can be used as components or sub-unit in a production line, with an unlimited number of sub-units, which, in combined operation operate as one large productive unit of distilled water and salt. Also, both portable and stationary distillation unit are ideal to function complementarily in small salt wells and rock basins, where they allow to improve the operating condition in favor of the producer and rendering the product both of better quality and greater quantity, with an outcome both competitive and viable from an economic viewpoint.

The ease of transport and installation of the units of the present invention offers the possibility of choosing a seaside location having as criteria the quality of the sea water source, in order for a natural product of the highest quality to be produced.

The use of the above-described sub-units to help and complement the production of salt from small salt wells and rock basins is the ideal solution in order:

i. to simultaneously produce distilled water and salt;
ii. to allow the producer to rest from persistent daily work;
iii. to significantly increase the capacity of salt production during the summer period and, moreover, to continue to produce throughout the winter period;
iv. to significantly improve product quality;
v. to allow the producer to use as many units as desired to achieve his desired output quantity

### PRIOR ART, MENTIONING THE DISADVANTAGES WHICH THE PRESENT INVENTION SOLVES

### Distillation Units

Distillation units process sea water and produce desalinated water. The productivity of the current units in relationship to the amount of sea water processed ranges from 10-33%. The remaining sea water of increased salinity which cannot be processed is handled and disposed of in accordance with the regulations set by the competent authorities.

### Salt Wells and Rock Basins

Distillation in salt wells and rock basins operates by exploitation of their geographic position, the morphology of the surface or of the rocks and physical phenomena such as tides and turbulence which flood them with sea water. After the receding of these physical phenomena, such wells and basins are further affected by the action of the sun, air, the phenomenon of evaporation and after conclusion of the self-concentration, salt is ready for harvesting. Many producers collect it once a year. Others try to accomplish two harvests, collecting the salt which has been produced in the middle of the summer and, afterwards, using portable pumps to fill the spaces again with sea water to accomplish a second production.

Before the harvest, producers remove seaweed and other foreign bodies, gathering the salt and, after hand cleaning, they move it to market.

### DISADVANTAGES OF PRIOR ART

### Desalination

Existing distillation units, in addition to their large expense of purchase and installation, carry considerable cost for operation, maintenance and spareparts, especially the frequent replacement of the membranes. They are energy consuming and, even worse, from the total sea water that they pump and process, the distilled water they produce, under the best of circumstances does not exceed ⅓ of the total quantity processed.

Besides that they are required to use additional electrical energy to discard the ⅔ of sea water which they are not able to utilize, they have problems handling the discarded raw material because of environmental restrictions. The remaining sea water which cannot be processed, has negative effects on the immediate area of the sea where it is discarded because of its increased salinity and, for this reason, it is quite difficult to obtain a permit for installation and operation of a distillation unit. Furthermore, in order to clean the membranes, chemicals are used which can find their way into the distilled water.

### Salt Wells—Rock Basins

Besides that they are unable to produce distilled water, these formations present the following difficulties in the production of salt.

During the period when the rock basins fill with sea water as a result of tide or turbulence, the water quality is variable.

The probable rainfall during the period from April to the first harvest at the end of August creates serious losses in the production of salt and, in rare circumstances where there is especially strong and prolonged rainfall, the entire harvest may be lost.

Often, the production is in danger of contamination by oil-slicks and, the worst is that the basins may also be polluted, with the result that one has cleaning costs are huge in relationship to the anticipated income. In most situations, oil slick pollution completely destroys the basin because it is impossible that this is cleaned.

It is painstaking and tiring work, which can also be hazardous, in that the harvest one moves or even shifts on an irregular and often sharp rock surface, and the workers must bend continuously to gather the salt from the variously sized basins in the rocks, to the extent that the task becomes manual.

After it is cleared of seaweed and other foreign bodies, the salt is packaged and taken to the local market, particularly the retail market, with the rest going to the wholesale market.

### BRIEF DESCRIPTION OF THE INVENTION

1. Construction of a Portable Distillation Unit

The invention is illustrated with the following example:

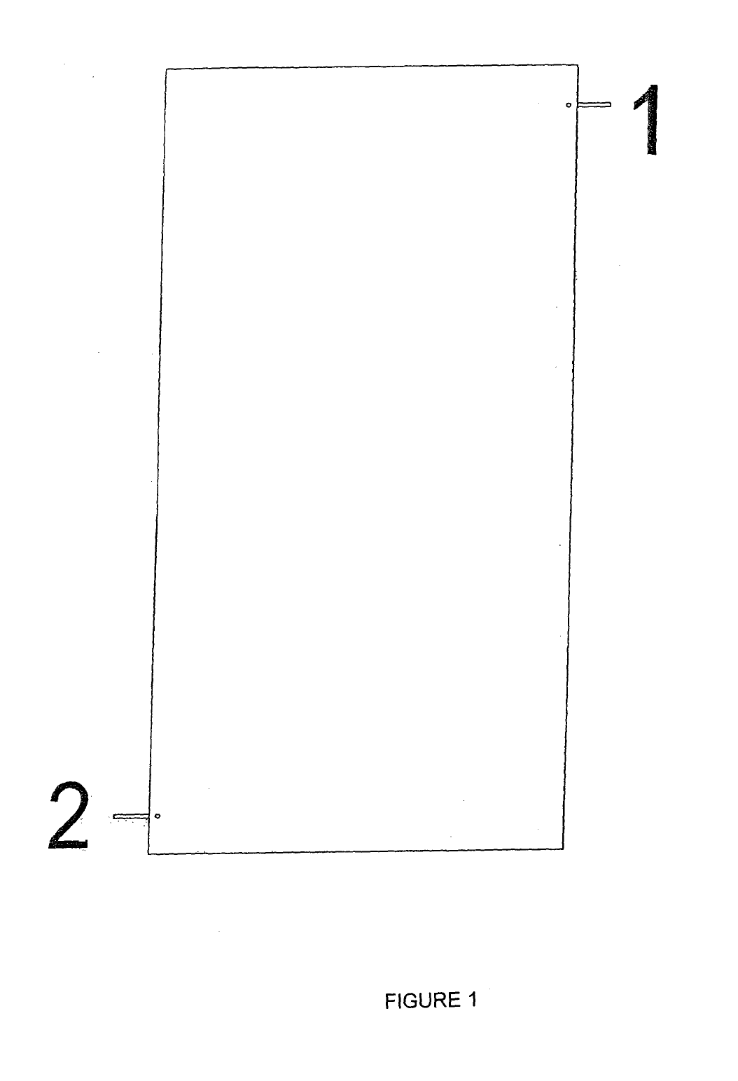

A pan is constructed of stainless or galvanized steel, with thickness of 1.5 mm, which has internal dimensions of 200×100×1 cm for the purpose of our example. At point 1 as shown in FIG. 1, a space is left for connection to a pipe which will bring in hot water and at point 2 as shown in FIG. 1, a space is left for connection to a pipe which will carry water out of the pan. The said pan is referred to as the double-bottom pan.

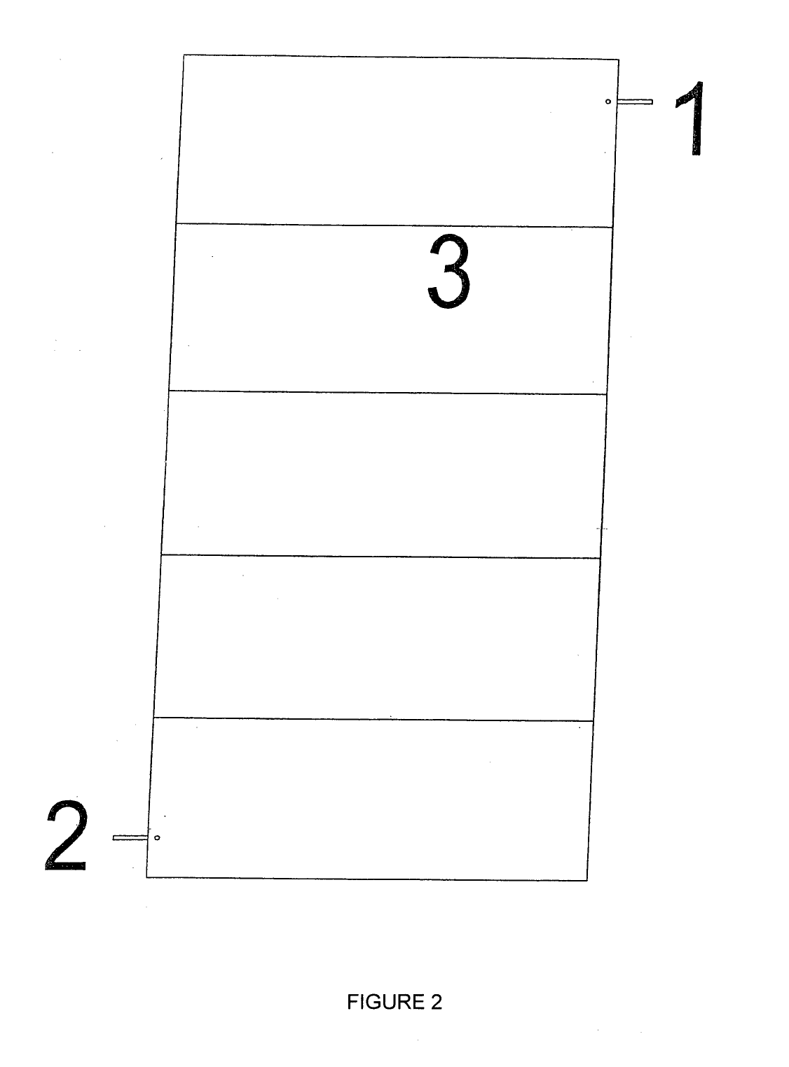

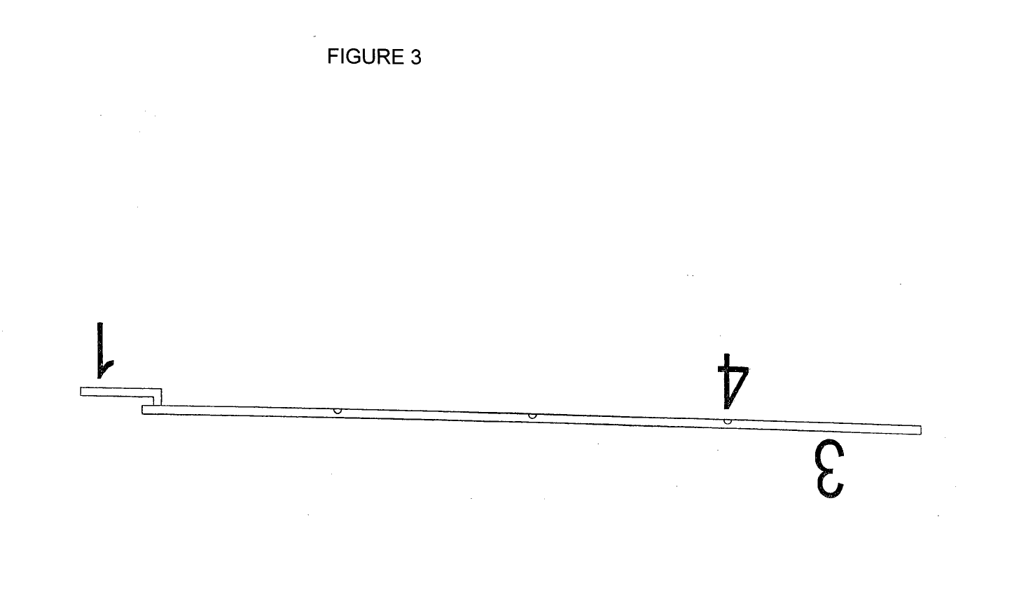

Inside the above-described pan are placed four (4) transverse vertical dividers so as to reinforce the surface of the double-bottom, as this is shown in FIG. 2. The said four transverse vertical dividers have openings in their lower sides so as to allow the free circulation of water, as is shown in FIG. 3.

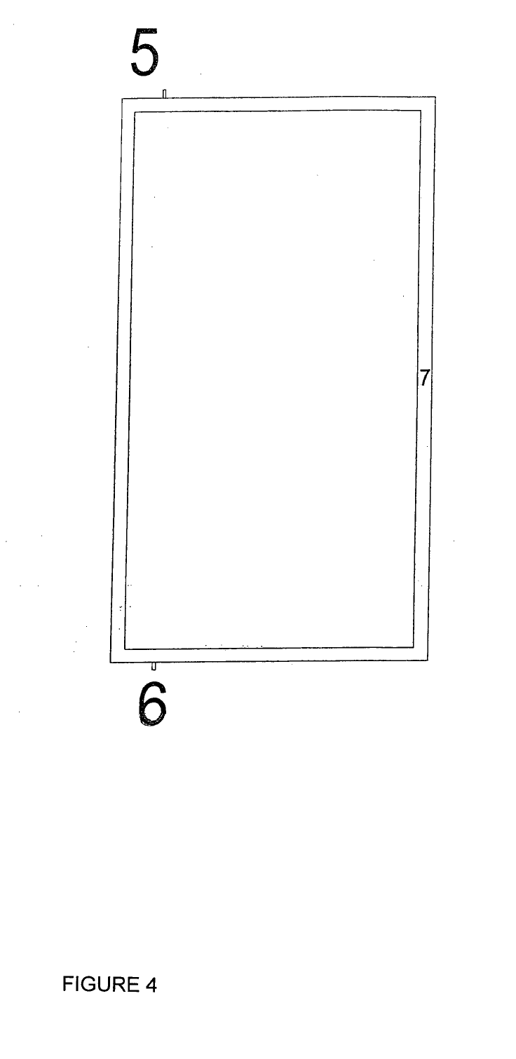

A second pan is constructed of stainless or galvanized steel, with similar thickness of 1.5 mm, with internal dimensions of 200×100×5 cm for the purpose of our example, and this is referred to as the evaporation pan. As it is shown in FIG. 4, at point 5 a space is left for the connection of a pipe which will carry sea water into the pan and, at point 6, a space is left for connection of a pipe to empty the pan.

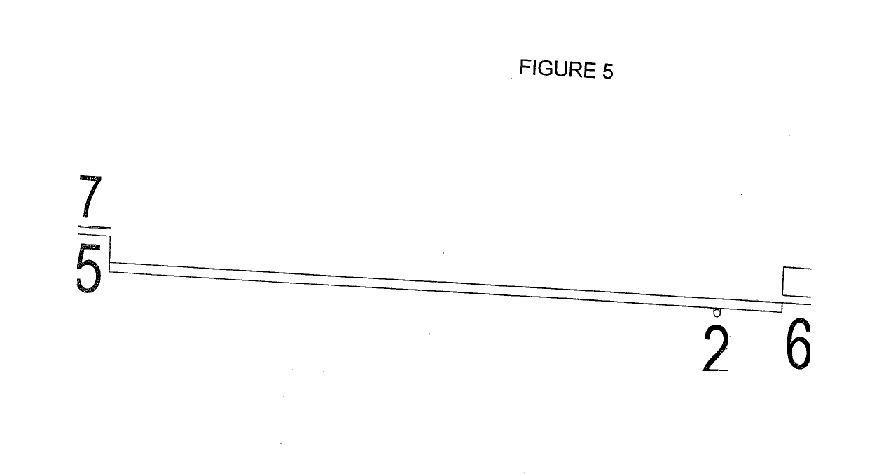

The bottom of the evaporation pan shown in FIG. 4 is placed on the rim of the pan shown in FIG. 2 and fastened along the seam, thus creating an evaporation pan with two bottoms. (FIG. 5)

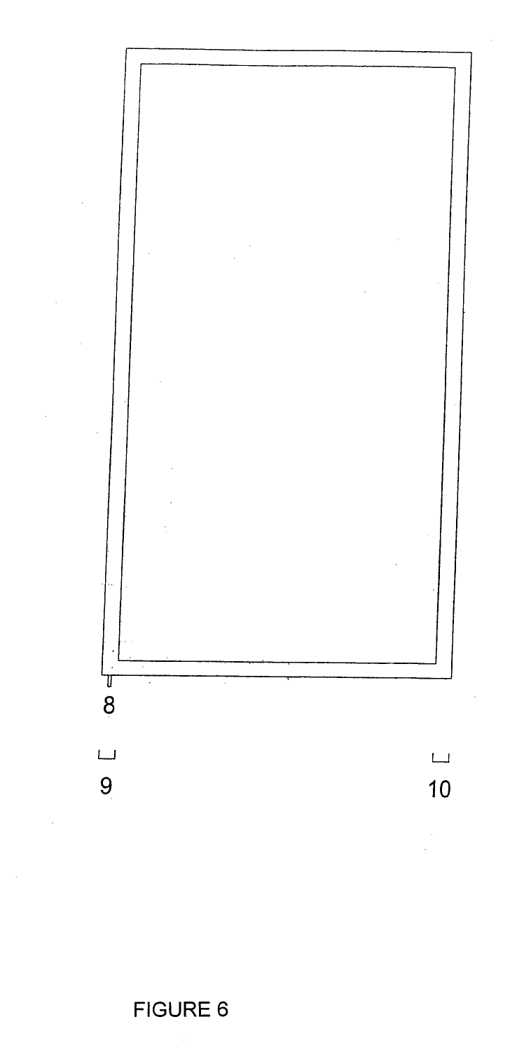

A metal ‘trough’ is constructed in the shape (in cross section) of the Greek letter π, with two sides having a 3 cm height in our example, connected by a 5 cm piece in our example. Four of these troughs are fastened together to form a parallelogram, referred to herein as the gutter, the interior surface of which (parallelogram) fits the internal opening of the evaporation pan, and this is 200×100 cm in our example, all this being showed in FIG. 6. At the end of one side of the gutter, a hole is opened to which a pipe is attached for the outflow of the distilled water which is collected in the gutter. The gutter is then inverted, with its open side facing up, is installed on the rim of the double-bottom evaporation pan and is fastened in place.

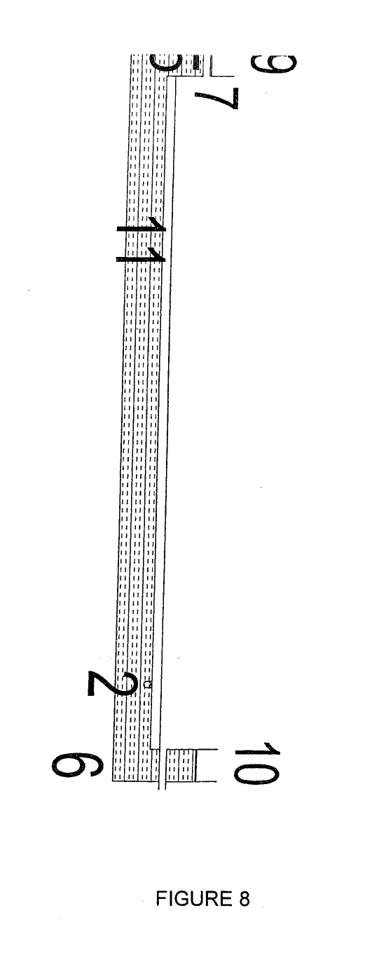

The bottom and outer sides of the unit are covered with insulation of a thickness and quality of our choice, and then this is held in place with sheeting material, the edges of which are fastened around the outer bottom sides of the rim gutter of the evaporation pan. In this way, the heat created in the double bottom of the evaporation pan is enhanced upwards, so that it will rise to heat the contents of the evaporation pan, as this is shown in FIG. 8.

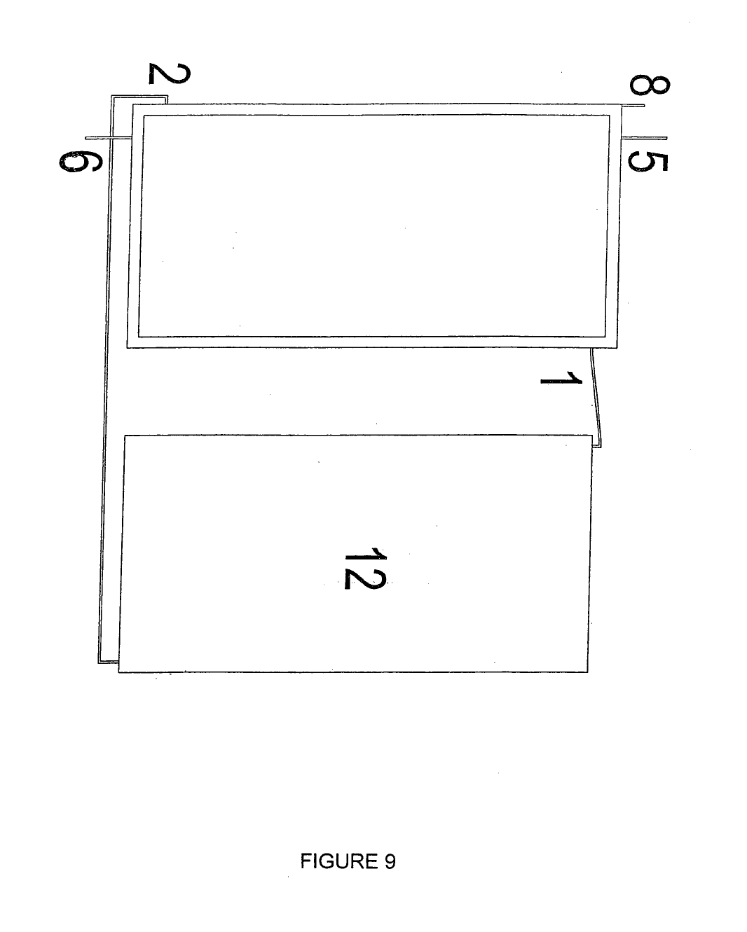

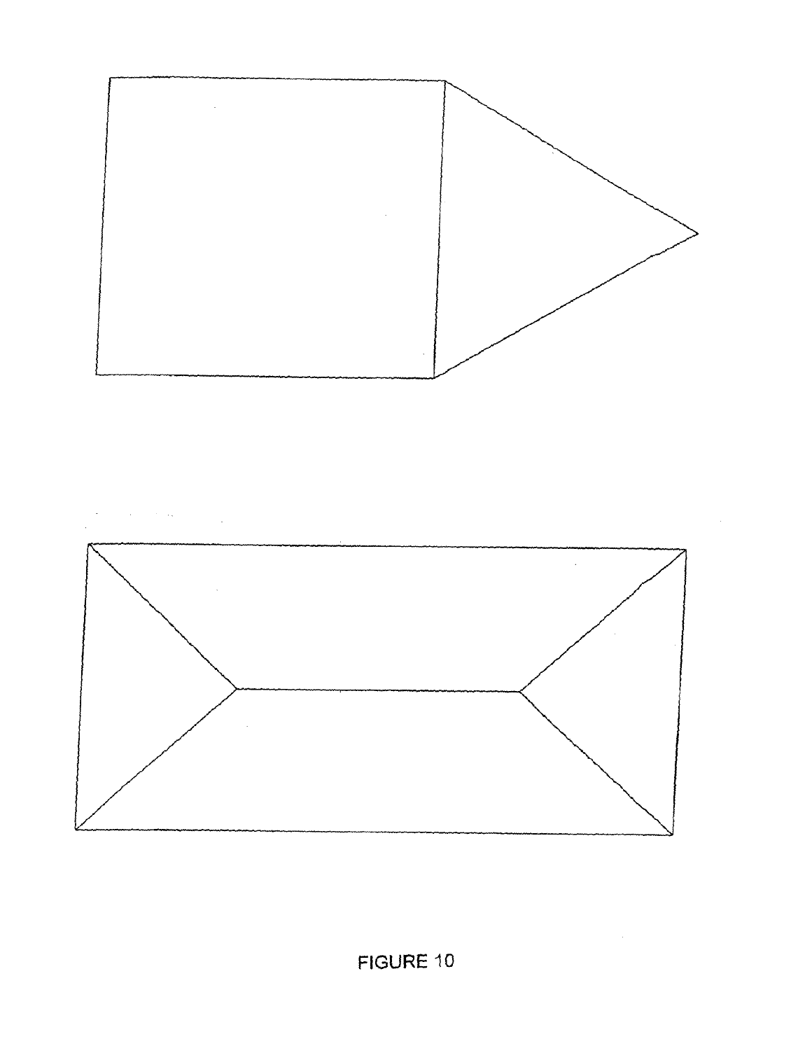

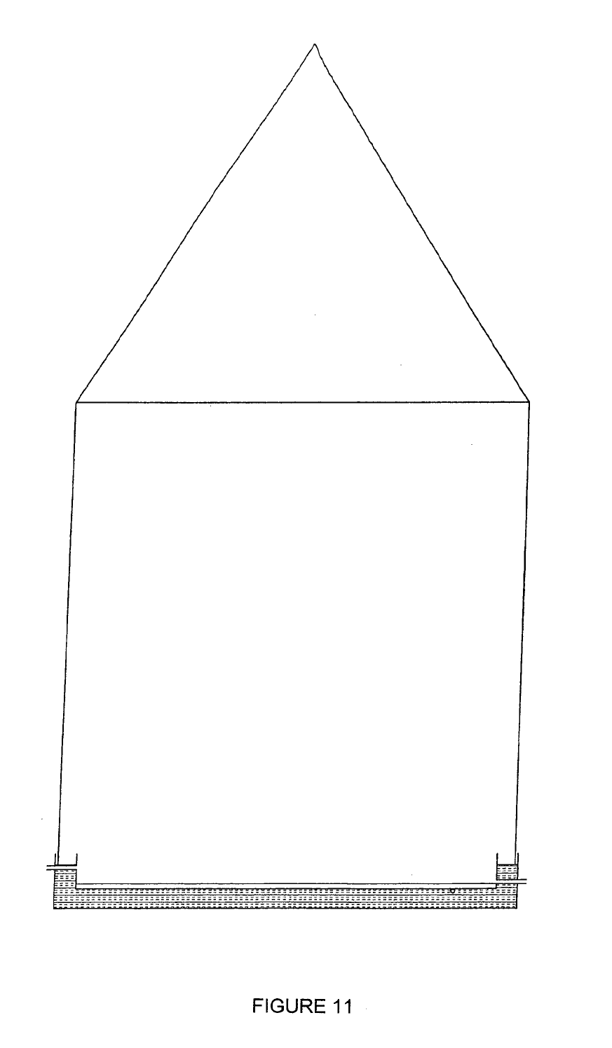

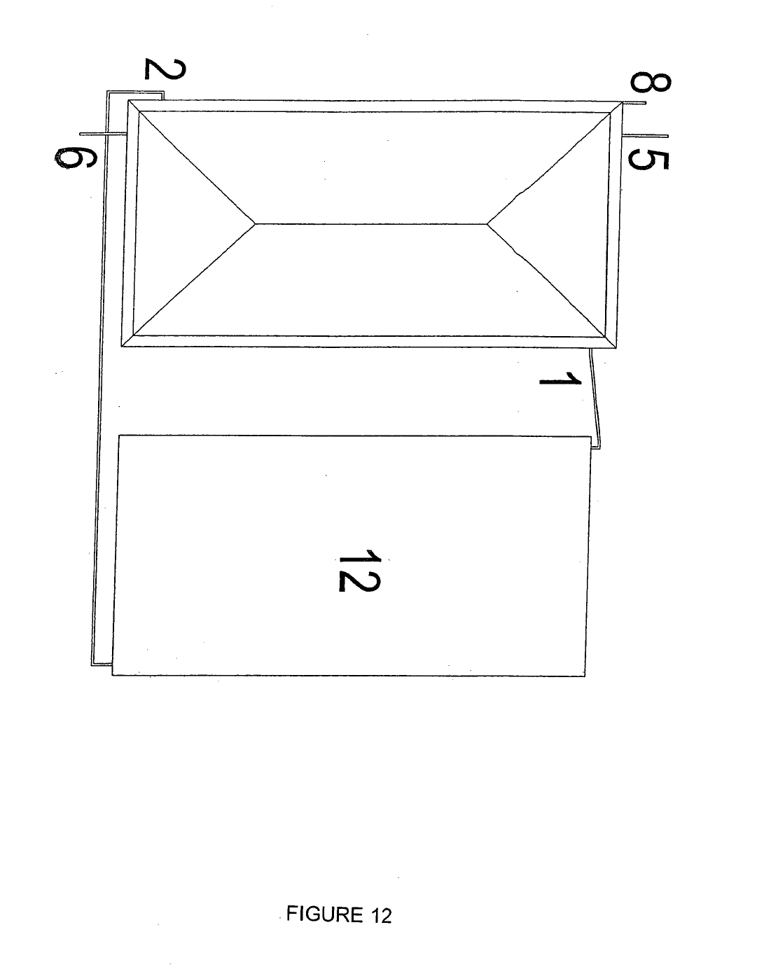

A solar collector panel with dimensions of 200×125 cm is placed in front of the double-bottomed evaporation pan and by one pipe the out-flow of the hot water coming out of the collector is connected to the hot water intake opening of the double bottom, and by another pipe we connect the cool-water intake of the solar collector is connected to the outflow opening of the double bottom, as this is shown in FIG. 9. With a light-weight, durable material of our choice, a frame is constructed in the shape of a tent, the height of which is also of our choice, but the base of which is a parallelogram, as is the gutter, with external dimensions 0.5 cm smaller than the external dimensions of the gutter, so that the base of the cover may be positioned into the space of the gutter. The frame is covered by a transparent film fastened in place, and is referred to as the evaporation pan cover. This is shown in FIG. 10. The base of the transparent film cover is positioned in the gutter and is fastened with a method of our choice. In this way, the construction of the portable distillation unit is completed, as this is shown in FIGS. 11 and 12.

This distillation unit, may also be used following the end of the distillation as a dehumidifier unit for salt crystals which remain inside the evaporation pan after complete evacuation of water. Alternatively, the salt crystals may be transferred to another unit to completely dehumidify.

The dimensions and specifications of materials that are mentioned in the present are indicative and should not be seen as restrictive.

### 2. Construction of a Stationary Distillation Unit

The surface of the ground is graded in the dimensions desired by the producer and in the current example, the area is a tract 5 m wide by 50 m long; the earth is then tamped down with a steammoller to create a depression with a solid, stable surface. On this surface is erected a pre-fabricated greenhouse frame of appropriate specifications, which in our example has external dimensions of 5 m width×50 m length. On the inside of the frame, and running completely around the perimeter, at a height ranging from 20 cm to 40 cm from the ground surface, a gutter is placed and fastened securely to the upright columns of the frame, which gutter has an inclination and at the lowest end of the gutter, an outflow pipe is attached to carry the distilled water to a tank. The entire frame is covered with transparent film, which is firmly fastened following the method and technique as used for covering greenhouses. After this, a strip of the same transparent film material, approximately 50 to 80 cm wide is prepared. One end of the strip is attached on the interior surface of the cover of the frame at a position that is higher than the gutter. Once the other end of the strip is stretched and fastened in the gutter and is held in place in such a way so that the water vapors that have sat on the interior surface of the cover, when they become liquid they will flow down the sides and will end into the gutter. To attach this strip of film to the inside of the cover of the frame, any adhesive material achieving adhesion may be used, or any other material. The bottom of the tamped earth depression inside the covered space may be protected with a layer of agricultural plastic or with any other insulation material.

Solar collectors are place outside, and along the length of the south-facing side of the stationary unit. Each collector is connected to a pipe which crosses the bottom of the structure and returns back to the solar collector, so as to deliver heat from the hot water produced by the collector to the sea water so as to hasten its evaporation.

The production of the stationary unit can be increased by increasing the surface of the solar collectors as well as by increasing the surface of the transparent film which captures the drops of water.

The dimensions and quality of materials referred to in this description are mentioned indicatively and not restrictively, and so is the number of solar collectors.

### Operation

### 1. Small Portable Unit

All-year round, on days expected to be sunny, the evaporation pan is filled with sea water, is covered and the transparent film cover is fastened securely, and the action of the sun begins the process of desalination. That is, the hot water from the solar collector enters the double bottom and heats the bottom of the evaporation pan, with the result that the sea water in the evaporation pan is heated both by the heat from below and its surface is also heated by the further action of the sun's rays which go through the transparent cover and heat the surface of the sea water. As a result, the process of evaporation begins, in which the warm and pending water molecules are trapped on the interior surface of the transparent film, as the temperature of the space is increased, the molecules are changed to steam, are turned into water and flowing on the surface of the transparent film are arriving in the gutter to be carried to the distilled water tank. When the sea water is completely evaporated, the cover is opened and the salt, which has remained in the evaporation pan, is collected. In experiments conducted by the inventors with a temporary model of this invention, approximately 15 Kilograms of distilled water and 600 grams of salt were collected per day. The unit can be operated autonomously or as a sub-unit where a number of sub-units are used for the distillation of water and another number as salt dehumidifiers and whiteners. Further, the use of a large number of portable units may create a production line of large productive capacity according to the needs of the producer.

It is possible to increase the production of the portable unit by connecting more solar collectors to the double-bottom evaporation pan, as well as by increasing the surface of the transparent film that traps the water molecules.

### 2. Stationary Unit

In the production area the basin is filled with sea water and, on sunny days, the sun heats both the interior space and the surface of the sea water, with the result that the desalination process is enhanced, and also evaporation is hastened by the hot water produced by the solar collectors and circulating inside the piping that crosses the evaporation area where the water molecules are trapped on the interior surface of the transparent film; the temperature of the enclosed space increases, transforming the water molecules to steam, these liquidify and droplets flow on the surface of the transparent film and flow downward ending up in the gutter and, from there, are carried to the distilled water collection tank. This process is repeated until all the sea water is exhausted. After the exhaustion of sea water, the salt is collect and the process is evaporated. The producer can either increase the size of the unit or the number of units so as to arrive at the desired level of production (output). It is also possible to combine the use of stationary and portable units to work together in a production line.

### Advantages of the Invention and Resolution of the Problems of The Prior Art

### Distilled Water

1. The most important advantage is the easy installation of a small or large distillation unit in areas we select.
2. Because the units can operate together, they can constitute a production line, the size and goals of which can be set by each producer and which can be expanded without limit.
3. All of the materials used to construct the unit are easy to handle, are reasonably priced and, most importantly, are produced in Greece, unlike existing units, which are expensive both to purchase and maintain, with this cost being paid to foreign suppliers.
4. Many of the tasks of construction and operation can be performed by any interested party, unlike existing units which require a large financial cost for the purchase, installation, maintenance and operation.
5. Unlike prior known units, the units of the present invention do not require hiring experts, maintenance costs of machines and replacement parts.
6. The distillation units of the invention operate solely with energy provided from the sun, do not pollute the environment, unlike existing units which are energy consuming and environmentally polluting.
7. The invention produces exceptionally clean distilled water without creating waste, exploits 100% of the sea water used, of which some 96% becomes dessalinated water and the remaining turns into 4% salt. In the contrary, existing units only 30% of the volume of sea water is obtained back, and the remaining 70% is considered waste water due to its high concentration in salt and requires special treatment, before being dumped back into the sea, to prevent damage to the ecosystem. This is the reason it is particularly difficult to obtain a permit for the installation and operation of a desalination unit.

Units as described in the present invention can solve the above problem by operating in parallel with existing desalination units, where the waste water of the prior art existing dessalination units may become the raw material for the distillation units of the present invention.

8. At the same time, salt of the highest quality is produced at no additional cost, opposite to the result of the prior are desalination units that produce waste water.
9. The flexibility and low cost of the units of the present invention can solve problems of water shortages in islands and in remote areas where potable water is not available. The existence of units of the present invention of a size suitable to supply the needs of certain coastal areas on islands can make transport of water from other parts of the island, and whatever this involves, unnecessary; this is not currently the case with existing prior art desalination units.
10. The units of the present invention can be a handy tool to enhance the viability of the small producer in salt wells and rock basins, suggesting the potential reopening of some 200 such micro-sites which have been closed as being non-profitable.
11. Besides the production of distilled water in an especially ecological way, at the same time and in the same operation, high quality salt is produced, which can be promoted internationally as a product with Greek appellation of origin. It should be noted that the product does not come into contact with the environment during the course of its production.

### BRIEF DESCRIPTION OF THE DRAWINGS

### Portable Unit

FIG. 1 shows the double-bottom pan of the example described above, made of metal 1.5 mm thick, with internal dimensions of 200×100×1 cm.

With number 1 is shown the hot water inflow pipe and with number 2 is shown the cold water exit pipe.

FIG. 2 shows the same double-bottom pan, into which have been placed four (4) transverse frames, the first of which is marked as number 3. The frames are placed here to support and prevent the formation of a depression in the evaporation pan. In our example this pan will be in the lower position of the double-bottom evaporation pan.

FIG. 3 shows a cross-section of the above-described evaporation pan, showing, at number 1, the hot water entrance (inflow) pipe, at number 3, the first frame with three openings to allow the circulation of water in the double bottom, and at number 4 the first of these openings.

FIG. 4 shows, in top-down view, a 1.5 mm thick metal evaporation pan with internal dimensions of 200×100×5 cm. With number 5 is shown the sea water entrance (inflow) and with number 6 is shown an exit pipe for brine. It is also shown how a gutter extends 5 cm horizontally from the rim, around the entire perimeter of the pan, as seen with number 7. In the figure, this pan is shown in the upper position of the double-bottom evaporation pan.

FIG. 5 shows a cross section of one side of the double-bottom evaporation pan, with the evaporation pan, which is here shown in the upper position, attached to the double bottom pan which constitutes the bottom of the evaporation pan. The hot water from the solar collector will flow into the space of 1 cm in height in the example, which space is created between the two pans. Number 2 shows the cold water exit pipe from the double-bottom. Number 5 shows the pipe through which sea water will enter the evaporation pan, number 6 shows the pipe through which brine will exit the pan and number 7 shows the rim of the pan.

FIG. 6 shows the top-down view of the gutter, with the same dimensions as the rim of the evaporation pan as well as the two cross-sections. Number 9 shows a cross-section of the left side of the gutter and number 10 shows a cross-section of the right side of the gutter. Number 8 shows the distilled water exit pipe.

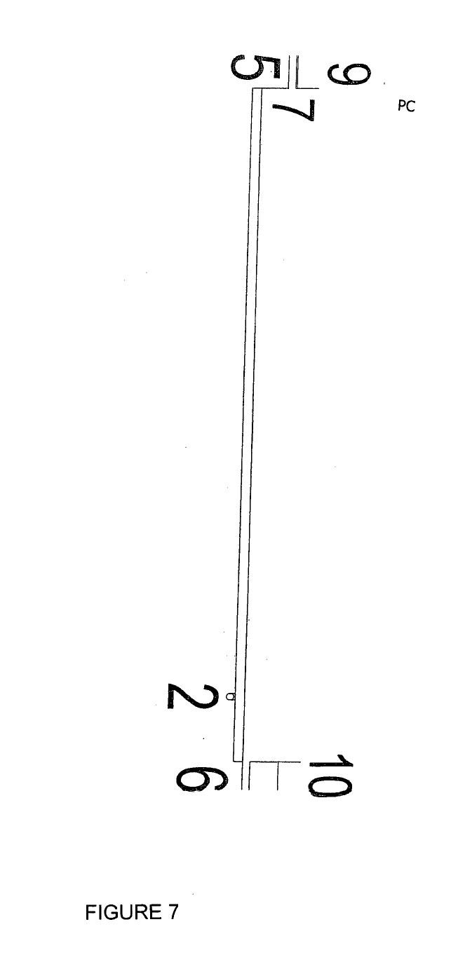

FIG. 7 shows a cross-section of the double-bottom evaporation pan with the gutter in place, where numbers 9 and 10 show cross sections of the gutter. Number 5 shows a section of the sea water entrance pipe where it enters the pan, number 6 shows a section of the brine exit pipe and number 2 shows the cool water exit pipe from the double-bottom.

FIG. 8 shows a cross section of the double-bottom pan covered with insulation, and the insulation covered by a sheeting layer (number 11).

FIG. 9 shows the double-bottom evaporation pan connected to the solar collector (number 12). Number 1 shows the hot water exit pipe exiting from the solar collector and that for the entrance of hot water into the double-bottom. Number 2 shows the exit pipe from the double-bottom and the entrance pipe for the cool water into the solar collector. Number 5 shows the sea water pipe for the entrance of sea water into the evaporation (upper) pan. Number 6 shows the pipe that carries brine out of the evaporation pan. Number 8 shows the pipe that carries out distilled water from the gutter into the fresh water collection tank.

FIG. 10 shows a top-down view of the evaporation pan cover frame seen, on the right hand side and, on the left-hand side, a cross section of the cover from transparent film.

FIG. 11 shows the double-bottom evaporation pan with the cover in place, which cover both traps the water molecules and protects the production area from any environmental pollution.

FIG. 12 shows the complete portable distillation unit for the simultaneous production of distilled water and salt.

### Stationary Unit

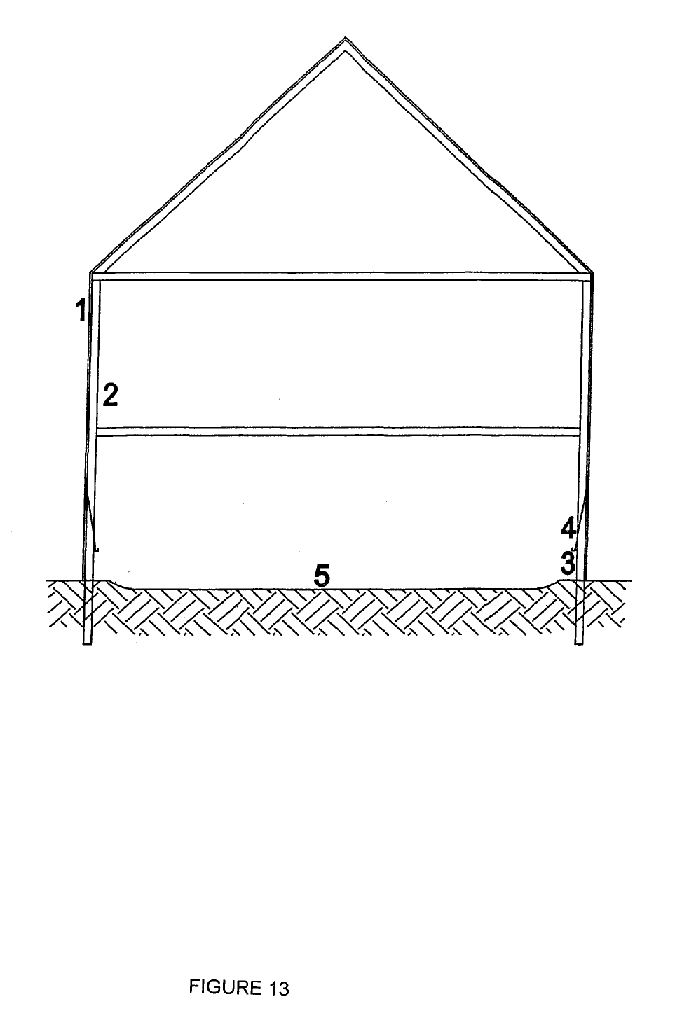

FIG. 13 shows a cross section of the stationary distillation unit. Number 1 indicates the transparent film which covers the stationary unit, number 2 indicates the frame, number 3 shows the gutter, number 4 the strip of transparent film which connects the interior surface of the film cover with the gutter and number 5 shows the permeable depression in the surface of the ground into which sea water is positioned for evaporation.

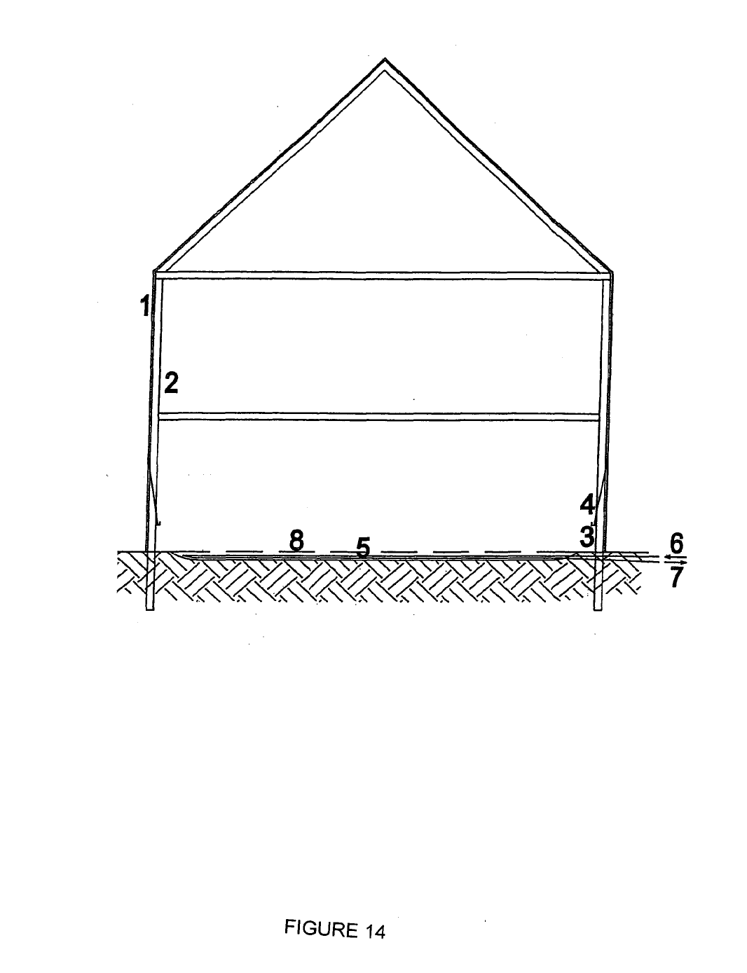

FIG. 14 shows a cross section of the stationary unit. Number 6 shows the entrance pipe for hot water coming from the solar collector, number shows 7 the pipe which returns cooled water to the solar collector and number 8 shows the level of the sea water.

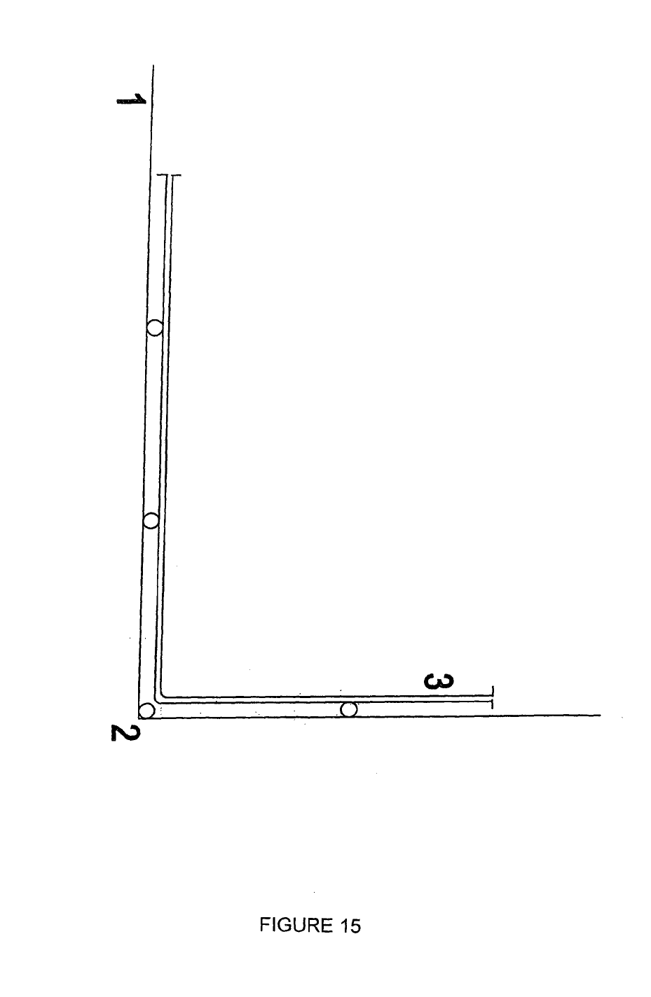

FIG. 15 shows a top-down view of a portion of the stationary unit. The line from number 1 indicates the transparent film which covers the unit, the circle at number 2 shows one of the metal columns of the unit and number 3 shows part of the gutter.

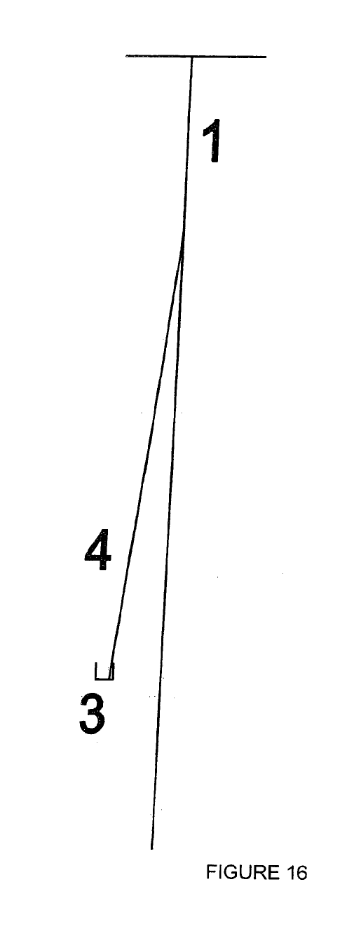

FIG. 16 shows in cross section a portion of the side wall of the unit. Number 1 shows part of the transparent film of the side wall, where the strip of transparent film (number 4) connects to the interior surface of the wall, from which drops of vapors that turned into water will flow down into the gutter (number 3).

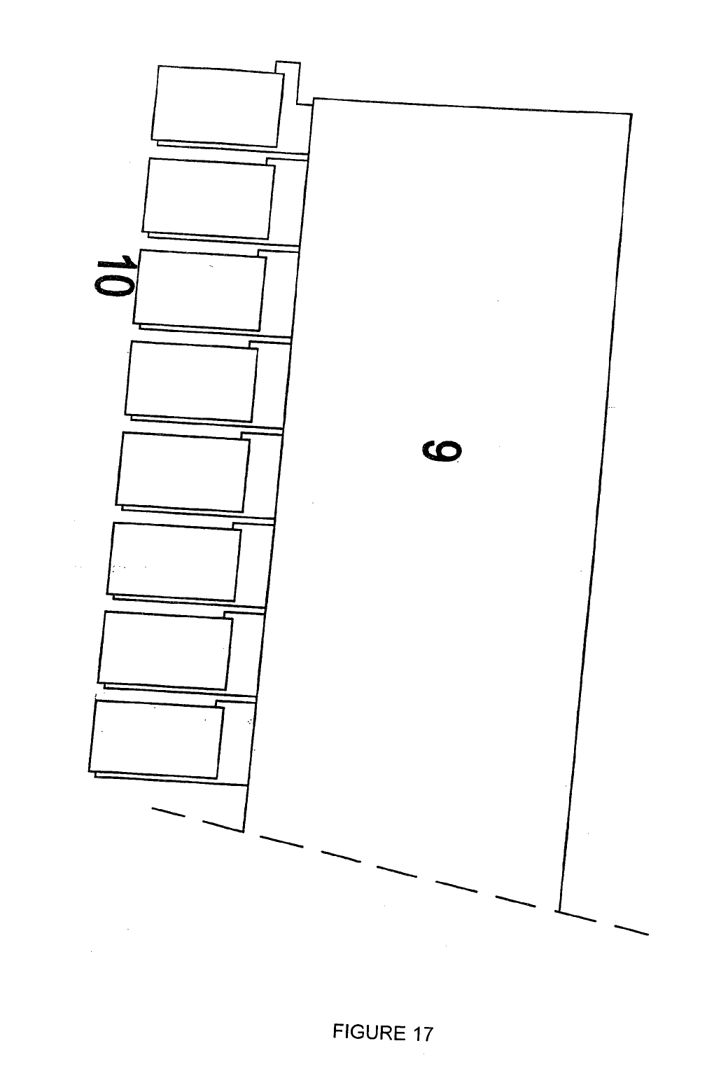

FIG. 17 shows a portion of the stationary unit, in which number 9 shows the production area and number 10 indicates the solar collectors.

### DETAILED PRESENTATION OF ONE EMBODIMENT OF THE INVENTION AS EXAMPLE

### Small Portable Unit

A pan is constructed of 1.5 mm thick stainless or galvanized steel, with internal dimensions of 200×100×1 cm. As shown in FIG. 1, number 1, space is left for connection to a pipe which will bring in hot water and, at number 2, space is left for connection to a pipe which will carry water out of the pan, which is referred to as the double-bottom.

Inside the above-described pan, in order to reinforce the double bottom and as shown in FIG. 2, four (4) vertical dividers are placed, which have openings in their lower sides to allow the free circulation of water as it is shown in FIG. 3.

A second pan is constructed of 1.5 mm thickness from stainless or galvanized steel, with internal dimensions of 200×100×5 cm, and is referred to as the evaporation pan. As is shown in FIG. 5, at number 5, space is left for the connection of a pipe which will carry sea water into the pan and, at number 6, space is left for connection of a pipe to empty the pan.

The bottom of the evaporation pan in FIG. 4 is placed on the rim of the pan in FIG. 2 and fastened along the seam, creating an evaporation pan with a double bottom. A cross section of the double-bottom evaporation pan is shown in FIG. 5.

A metal ‘trough’ is constructed having in cross section the shape of the Greek letter π, with two sides 3 cm long connected by a piece 5 cm long. Four of these troughs, two long and two short, are fastened together to form a parallelogram, referred to as the gutter, the interior surface of which parallelogram fits the internal opening of the evaporation pan which has dimensions of 200×100 cm, as seen in FIG. 6. At the end of one side of the gutter, a hole is opened to which a pipe is attached for the outflow of the distilled water collected in the gutter. The gutter is then inverted, with its open side facing up, installed on the rim of the double-bottom evaporation pan and fastened in place. A cross-section of the double-bottomed evaporation pan with positioned gutter is depicted in FIG. 7.

The bottom and outer sides of the unit are covered with insulation of a thickness and quality of our choice, and then this is held in place with sheeting material, the edges of which are fastened around the outer bottom sides of the rim gutter of the evaporation pan. In this way, the heat created in the double bottom of the evaporation pan is enhanced, so that it will rise to heat the contents of the evaporation pan, as this is shown in FIG. 8.

A solar collector panel with dimensions of 200×125 cm is placed in front of the double-bottomed evaporation pan and is connected by one pipe, which carries the hot water out of the collector to the intake opening of the double bottom, and another pipe, which returns cooled water from the outflow opening of the double bottom to the cold water intake of the solar collector. This is shown in FIG. 9.

With a light-weight, durable material of our choice, a frame is constructed in the shape of a tent, the height of which is also of our choice, but the base of which is a to parallelogram, as is the gutter, with external dimensions 0.5 cm smaller than the external dimensions of the gutter, so that the base of the cover can be set into the gutter, the frame is covered by a transparent film fastened in place, and is referred to as the evaporation pan cover. FIG. 10 shows a top-down view of the cover on the left hand side and on the left hand side one of the views.

We position the base of the cover from transparent film into the gutter and we fasten this in a manner we prefer, as shown in example in FIG. 11.

FIG. 12 shows the complete portable desalination unit.

This desalination unit can also be used as a dehumidifier unit for salt crystals, which remain inside the evaporation pan after complete evaporation of water, or the salt crystals can be transferred to another unit to completely dehumidify.

The portable unit can be positioned in a place of our choice, filled with sea water and, after a few days have passed, when the sea water has been completely evaporated, the now distilled water is collected in the tank and the salt remains in the evaporation pan. After this, the salt can be left to dehumidify in the same unit or the raw salt can be transferred to another unit being used for dehumidification, while the first distillation unit is refilled with sea water and the desalination process is continued. The number of days required for the complete evaporation of one quantity of sea water depends on the duration of sunshine.

The unit may operate autonomously or as a sub-unit in a group of such units, some of which perform distillation and others dehumidification/whitening. Further, the use of a large number of portable units may create a line capable of large-scale production, according to the needs of the producer.

### Stationary Desalination Unit

The surface of the ground is graded in the dimensions desired by the producer. In the current example, the area is a tract 5 m wide by 50 m long. The earth is then tamped down with a steammoller to create a depression with a solid, stable surface. A pre-fabricated metal greenhouse frame is then erected, in this example, with dimensions of 5 m by 50 m. On the inside, around the entire width and length of this frame, at a height sloping from 20 to 45 cm from the ground surface, a gutter is attached, which stabilizes the upright columns of the frame and at the lowest point of the gutter, a pipe is connected to carry the distilled water from the unit to a collection tank. The entire frame is covered and stabilized with transparent film, which is firmly fastened using the method and technique as used for covering greenhouses. After this, a strip of the same transparent film material, approximately 50 to 80 cm wide is prepared. One long side of the strip is attached around the interior of the cover. The other long side rests in the gutter and is held in place in such a way that the drops of condensation on the interior of the cover will fall down the sides and flow into the gutter. To attach this strip of film to the frame cover film, transparent self-adhesive packaging tape may be used or any other material.

The bottom of the depression inside the covered space is lined with agricultural plastic or with another appropriate insulating material.

The gutter of the stationary unit is connected to a tank for collection of the distilled water.

Along the length of the south side of the covered space, solar collectors are installed. Each is connected by a pipe that carries hot water from the solar collector, enters and crosses the evaporation space carrying heat to the sea water and returns to the intake pipe of the solar collector. This arrangement is repeated for each solar collector.

The evaporation pan depression is filled with sea water which, during periods of sunshine, is heated both by the heat build-up in the covered space and by the water heated in and circulated by the pipes from the solar collectors.

Water molecules which rise (evaporate) from the heated sea water in the evaporation pan are caught on the interior surface of the cover and transform into water droplets, which flow down the interior surface of the film into the gutter and from there into the distilled water tank.

After a period of some days, when the sea water has been completely evaporated, the now distilled water is in the tank and the salt remains inside the evaporation pan. The salt can be collected and removed so as to free up the space for a repetition of the operation.

The unit can be used autonomously or used as a sub-unit of a large array of similar units, with a large productive capacity, according to the needs of the producer.

Likewise, the units may be used in conjunction with stationary and portable units as sub-units of a large-capacity operation as follows: One series of stationary sub-units can be used for evaporation of sea water until the salinity is approximately 24-25%, which salinity makes the brine to be considered to be brine of the necessary density to produce salt crystals, and then this brine can be transferred to portable units in which evaporation will be completed and crystal salt produced.

The damp salt can then be transferred to another series of sub-units in which it will remain until completely dehumidified and whitened.

1. A portable water distillation unit comprising:
i. A double-bottom evaporation pan that is to be filled with sea water, comprising an open, upper pan where sea water is to be put and a closed, bottom pan that is defined by the two bottoms, wherein the bottom of the upper evaporation pan forms the top of the double bottom, in which evaporation pan the hot water circulates and the heat is transferred to the bottom of the evaporation pan and the sea water it holds; said portable double-bottom evaporation pan can be used as an autonomous unit for the production of distilled water and salt or as a sub-unit of a production array of an unlimited number of sub-units which in combination is capable of producing large quantities of distilled water and salt.
ii. The rim of the evaporation pan is constructed to operate as a gutter, that is, an inverted metal π, positioned and attached around the perimeter of the rim of the evaporation pan, where liquidified vapors of water will be caught and carried away by a pipe connected to the fresh water collection tank.
iii. A cover over the evaporation pan fabricated with a light, flexible frame covered by transparent film the base of which is set into the gutter, so that the drops of the liquidified vapors of water flow down the interior surface of the transparent film into the gutter.
iv. One or more solar collectors, which is connected by two pipes with the closed, lower double bottom container of the double-bottom evaporation pan; the hot water exit pipe of the solar collector is connected with the hot water entrance pipe of the double bottom and the exit pipe for cooled water from the double bottom is connected with the water intake pipe of the solar collector.

2. A portable water distillation unit according to claim 1, characterised in that the special construction of the rim of the evaporating pan allows that the base of the cover is positioned within the limits of the rim of the pan and operates as water collector of the water vapors that are created into the space and that within the evaporation pan is positioned sea water or ripe brine for evaporation and for the production of distilled water and salt.

3. Portable water distillation unit according to claim 1, characterised in that
the cover of the frame is covered with transparent film, the interior surface of which traps the water vapors, which then become liquid, flow down in the internal surface of the film into the gutter and into the water collection tank as distilled water;
the evaporation pan holds sea water or ripe brine to be evaporated and to produce distilled water and salt;
the cover from transparent film material prevents foreign bodies and other pollutants from entering the evaporation pan.

4. A stationary water distillation unit comprising:
i. an evaporation basin for sea water formed by a depression made in the ground and lined with agricultural plastic or with other appropriate material;
ii. a metal frame similar to that of greenhouse type covered with transparent film which operates as a cover for the evaporation pan and which is further characterized by that it:
a. bears a gutter positioned internally, at a low level around the interior side of the frame for the collection of liquidified water vapor which flow down the interior surface of the transparent film, and
b. has a strip of transparent film, the one edge of which is fastened around the interior of the transparent film cover and the other edge of which is fastened in the gutter so that the droplets of liquidified water vapors flow on the interior surface of the transparent film cover into the gutter;
iii. a series of solar collectors, each of one which is connected to a pipe which enters and crosses the bottom of the evaporation pan transferring heat to the sea water in the pan, and then returns to the water intake opening of the solar collector.
The stationary unit may be used as an autonomous unit of production of distilled water and salt with the insertion of sea water and the production of distilled water and salt, or it may also be used as a sub-unit in a production line with an unlimited number of sub-units, in which they will cooperate as one large unit for the production of distilled water and salt.

5. A stationary water distillation unit according to claim 4, characterised in that there is a specially constructed gutter, fastened around the interior perimeter of the stationary unit a few centimeters above the ground surface, which gutter operates as a collector for the water vapors created inside the space, and that into the evaporation pan we position sea water for it to be evaporated, for the production of distilled water and salt.

6. A stationary water distillation unit according to claim 1, characterised in that
the cover of the frame is covered with transparent film, the interior surfaces of which capture the water vapors and these subsequently liquidity, flow down the interior surface of the film into the gutter and into the water collection tank as distilled water,
while the evaporation pan is filled with sea water or ripe brine to be evaporated, for the production of distilled water and salt and
the cover from transparent film material prevents foreign bodies and other pollutants from entering the evaporation pan.

7. A water distillation system, wherein after the processing in a stationary water distillation unit according to claim 1 of sea water into ripe brine of 24-25% salinity, the brine is then transferred into portable units according to claim 1, in which portable units the remaining water is fully evaporated and salt is produced, following which the humid salt is transferred to portable distillation units that are to operate as dehumidifiers/whiteners, where said salt passes through successive stages of processing for the production of distilled water and salt and where the product of one stage is transferred into the next stage.

8. A system of water distillation units according to claim 1, wherein a number of stationary and portable water distillation units are used in combination as sub-units for the processing of brine and salt, such being used as desalinators and dehumidifiers-whiteners, where said stationary and portable water distillation units operate as successive stages of processing for the production of distilled water and salt and where the product of one stage is transferred to the next stage.

9. Method of operation of water distillation units according to claim 7, with the following steps:
partial evaporation of sea water in stationary sub-units,
the ripe brine is then transferred to portable desalination sub-units which will be used for the complete evaporation of the brine and the production of salt,
the fresh salt is then transferred to portable sub-units which will be used as dehumidifiers-whiteners,
wherein the salt passes through successive stages of processing for the production of distilled water and salt and wherein the product of one stage is transferred to the next stage as the raw material for that next stage and
wherein, in order to maximize the production of distilled water in the first step, of distilled water and salt in the second step, and of dehumidified-whitened salt at the third step, a large number of portable desalination sub-units is required for each stationary desalination sub-unit.
